(19) United States
(12) Patent Application Publication
(10) Pub. No.: US 2015/0090805 A1
(43) Pub. Date: Apr. 2, 2015

(54) Methods and Apparatus for Destabilizing Tornadoes

(71) Applicant: Allen M. BISSELL, Chevy Chase, MD (US)

(72) Inventor: Allen M. Bissell, Chevy Chase, MD (US)

(21) Appl. No.: 14/391,584

(22) PCT Filed: Apr. 9, 2013
(86) PCT No.: PCT/US13/35741

§ 371 Date: Oct. 9, 2014

Related U.S. Application Data
(60) Provisional application No. 61/622,327, filed on Apr. 10, 2012.

(51) Int. Cl. A01G 15/00; B64D 1/12; B64B 1/40

(52) U.S. Cl. CPC A01G 15/00; B64B 1/40; B64D 1/12
USPC 239/2.1; 239/14.1

(57) ABSTRACT

Methods and apparatus for destabilizing and reducing the strength and even destroying tornadoes are disclosed. Rather than over-powering a tornado, tornado vulnerabilities in stability maintenance are identified and turned against the tornado. Embodiments include attacking tornado vulnerabilities chemically without the use of explosives. Selected chemicals are introduced into a tornado adjacent to the wall of the funnel, advantageously above the height of entrained debris, to reduce the transmission of local angular velocity of the funnel toward the earth and to attack the local generation of energy from the tornado's air/water mixture.

### TECHNICAL FIELD

This invention relates to methods and apparatus for destroying tornadoes.

### BACKGROUND

Today, the United States can expect sufficient tornadic weather through each year to produce nearly $1 billion in property damage and the loss of 100 lives. Atmospheric humidity is increasing due to a gradually warming climate, producing increased evaporation on the planet. This results in an increase in the energy stored in the atmosphere from the latent heat of vaporization of water (970 British thermal units (BTU) per pound), which more than any other evaporative liquid, contributes to the atmospheric energy content. This energy must find mechanisms to dissipate itself or the atmosphere cannot avoid overheating and making the planet uninhabitable.

In “Tornado Alley” in the Mid-West of the U.S., convection currents carrying heated moist surface air aloft contribute to atmospheric instability, which can organize into storm super-cells. Wind shear aloft, typically arising from the collision of warm moisture-laden fronts moving north from the Gulf of Mexico and cold fronts moving from the west, produces vortices in low-pressure centers of rotation in the air/water mixture in the cloud scud. The mixing of warm and cold air releases energy, producing vortex funnels, which reach down toward the earth through a sucking action at the lower end of the vortex. Contact with the earth has an effect of sealing off the interior of the funnel from the local atmospheric pressure so that the relative vacuum/low pressure inside increases, thereby pulling the surrounding air/water/entrained mass mixture toward the funnel and decreasing the radius of gyration about the funnel, which then increases the rotational velocity of the vortex. This then becomes a tornado. It maintains itself by rotational energy coming down the funnel from the wind shear, from intermixing of the hot and cold air flows, and from the latent heat of evaporation of entrained moisture raining down from the super-cell above or being sucked up from the earth.

The destructive power available to a typical F3 tornado is large. This power can be estimated by considering that the low pressure of the funnel and its immediate surroundings can evaporate 100 pounds of water per second, with each pound of water liberating 970 BTU, which contains 778 foot-pounds of energy per BTU. Since one horsepower is defined as 550 foot-pounds of work energy expended per second, then the horsepower of such a vortex is:

100 lb/sec×970 BTU/lb×778 ft-lb/BTU×1 HP/550 ft-lb/sec=137,211 HP

This power is expended by driving air, water, and entrained debris around the funnel at approximately 140 miles per hour. Any object, such as man-made structures, trees, vehicles, livestock, or loose debris, is bombarded with other masses travelling at nearly 140 mph so that a buzz-saw effect occurs, utterly destroying almost anything in the path of a tornado funnel and its associated whirling debris field. This then is a statement of the problem. What can be done to destroy these most destructive vortices?

Known approaches to tornado destruction include U.S. Pat. No. 7,810,420 to Konstantinovskiy and U.S. Patent Application Publications No. US 2002/0088364 by Feldman and No. US 2005/0039626 by Yi et al. The Konstantinovskiy patent describes interrupting a tornado by releasing an ultra-cold substance, such as liquid nitrogen, at a low altitude in an area of ongoing tornadic activity. The Feldman publication describes destroying a tornado by releasing a liquid fuel-air explosive in chosen areas of the tornado by pilotless drone aircraft. The Yi publication describes using a ground-based array of multiple jet devices to produce man-made tornados or explosive devices that divert or stop natural tornadoes. Other known approaches to tornado destruction include missile batteries deployed around the countryside.

Of course, such approaches have problems. Introducing ordnance into a tornado and through an entrained debris field would subject a missile or aircraft to damage to control surfaces, endangering public safety by an uncontrolled trajectory of a damaged missile or aircraft. Even tracking tornadoes is difficult with current missile seeker heads.

### SUMMARY

This invention is directed to destabilizing and reducing the strength and even destroying tornadoes without the problems of known approaches. Instead of depending on overpowering a tornado, this invention relies on identifying tornado vulnerabilities in stability maintenance and attempting to turn a tornado's strengths against it. For public safety and cost considerations, embodiments of this invention include attacking tornado vulnerabilities chemically without the use of explosives. Selected chemicals are introduced into a tornado adjacent to the wall of the funnel, above the height of the entrained debris, to attack the local generation of energy from the air/water mixture, and to reduce the transmission of local angular velocity of the funnel toward the earth.

In accordance with aspects of this invention, there is provided a method of destabilizing a tornado. The method includes selecting at least one chemical that interferes with transmission of angular momentum from a higher portion of the tornado to a lower portion of the tornado; and directionally distributing the at least one chemical adjacent to a wall of the tornado. The at least one chemical in the tornado decreases a local wind angular velocity at a portion of a cross-section of the tornado, thereby causing energy and rotational deficits within the tornado.

Also in accordance with aspects of this invention, there is provided an apparatus for distributing at least one chemical into a tornado. The apparatus includes a payload container; a lift device for lifting the payload container to a selected height near the tornado, the lift device routing the payload container toward a wall of the tornado by inward spiral wind flow of the tornado; a lift activation device configured for activating the lift device; a payload altitude control device configured for releasing the lift device from the payload container when the lift device and payload container reach a predetermined altitude; and a payload release device configured for releasing content of the payload container at the predetermined altitude and upon occurrence of a predetermined condition.

### BRIEF DESCRIPTION OF THE DRAWINGS

The several objects, features, and advantages of this invention will be understood by reading this description in conjunction with the drawings, in which:

FIG. 1 is a flow chart of a method of destabilizing a tornado;

FIG. 2 is a block diagram of an apparatus for directionally distributing at least one chemical into a tornado; and

FIG. 3 is a flow chart of a method for directionally distributing at least one chemical into a tornado.

### DETAILED DESCRIPTION

There are constraints under which any tornado must operate in order to remain stable, to continue to liberate sufficient energy to maintain the funnel and internal vacuum in contact with the earth and the cloud scud above, and to replenish the air circulation around it.

A first constraint is that a tornado must strictly obey the laws of conservation of linear and angular momentum. Thus for a tornado to maintain its strength, every bit of angular momentum departing a tornado by loss of mass and kinetic energy to the environment through friction with the earth and collision with objects must be made up simultaneously with other mass picked up by the whirling winds and added to the total angular momentum inventory of the tornado so that the total remains constant. In other words:

M₁×R₁×ω₁=C=M₂×R₂×ω₂

in which M represents the tornado's total mass, R represents the radius of gyration of the tornado, ω represents the angular velocity of the tornado in radians per second, and C represents the angular momentum. The subscripts represent the conditions before and after an event such as loss of a mass where a mass strikes and imbeds into a structure, transferring its angular momentum into the structure and ultimately out of the tornado and into the earth. Thus there has been a loss of mass so that M₂ is smaller than M₁.

The radius of gyration of a rotating mass, such as a tornado, is the weighted average radius of the mass. This can be calculated for a circular object by taking the square root of the polar moment of inertia, I, about the axis of rotation divided by the area of the tornado's cross section. For a substantially circular tornado, the radius of gyration R is given by the following:

R=(I/A)^{1/2}=(π/2r⁴/πr²)^{1/2}=r/√2

in which I represents the polar moment of inertia, A represents the cross-sectional area of the funnel plus the debris field, and r represents the radius of the debris field which includes the funnel within. The preceding expression also represents a spinning skater who extends her arms to reduce or stop the spin and pulls her arms in close to her body to increase her spin. In this example, the spinning skater's mass does not change, but angular momentum is conserved because the radius of gyration reset itself automatically by recomputing R=(I/A)^{1/2}.

If there is any deficit of replacement angular momentum in a tornado, there will be an immediate loss of angular velocity ω around the funnel, and the tornado, which must maintain its angular momentum at least constant, struggles to survive. This loss of angular velocity reduces the tornado's ability to pick up mass into the circulation around the funnel, and so the radius of gyration R of the already included mass gets larger as the whirling circulation slows, causing even more mass to be dumped onto the ground.

In addition, the local atmospheric pressure rises as velocity falls in accordance with Bernoulli's law, and the funnel begins to unbalance and wobble by continuing to shed its mass. The inventor has recognized that at the end of a tornado's time in contact with the earth, the lower portion of the funnel becomes more disorganized and separates from the upper reaches of the funnel, which then can no longer suck its way back down to the earth. The upper part of the tornado then disappears up into the cloud scud above, and the tornadic effects dissipate rapidly. A tornado's basic lack of stability can be understood from the typically short tornado life spans of less than three minutes, and the rarity of tornadoes lasting thirty minutes or longer and travelling more than a mile (1.6 kilometers) or two before breaking up. The inventor has recognized that a tornado system is astable and can be broken up without having to bring large explosive forces to bear on the funnel.

A tornado must extract energy from the moisture in its cloud scud surroundings according to the expressions described above, and then convert that energy into rotational wind velocity, which originally started up the rotation, and continue to transmit extracted rotational energy down the funnel to the earth. The inventor has recognized that interference with this downward transmission of angular momentum, which assists the tornado as a whole to maintain itself, can cause the tornado to run out of kinetic energy and no longer produce work against the earth.

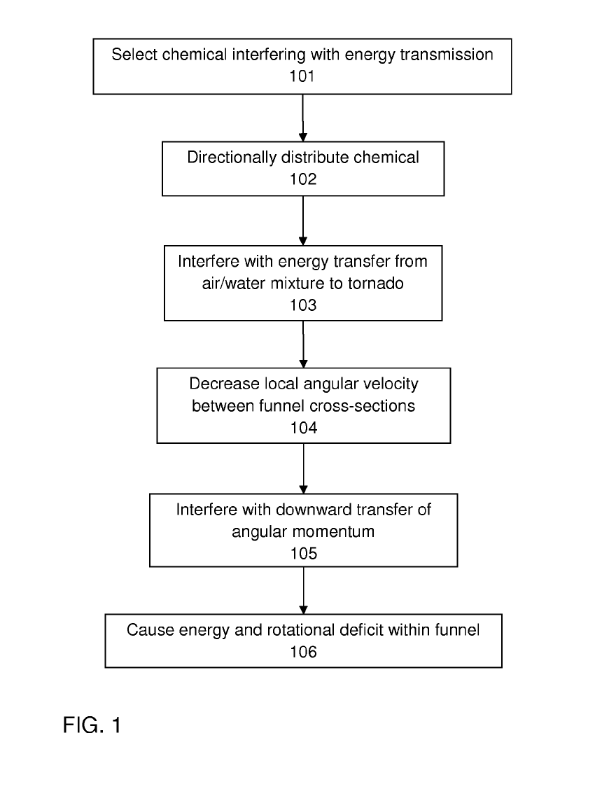

FIG. 1 is a flow chart illustrating an example of a method of destabilizing a tornado in accordance with this invention. It will be understood that other methods in accordance with this invention can have more or fewer steps, as determined by the appended claims.

In step 101, at least one chemical is selected that can interfere with transmission of angular momentum from an upper portion of a tornado to a lower portion of the tornado. The one or more chemicals can be selected from a group of petroleum distillates, ethers, alcohols, misted slip-glycerins, and waxes. For example, volatile petroleum distillates can be selected that will rapidly cool the local rising moisture-laden air in and around a tornado, reduce the dynamic viscosity of the tornado's air/water mixture, and raise the local atmospheric pressure in the funnel by flashing into vapor.

In step 102, the selected one or more chemicals are directionally distributed into a tornado's funnel. Directional distribution can be carried out in a number of ways, for example by an apparatus that carries the chemicals into the funnel wall. Suitable apparatuses are described in more detail below, and include an apparatus that can be released from the ground, ascend to a selected altitude of preferably at least about 300 feet (100 meters), and be carried by the tornado's spiral wind flow into close proximity to the wall of the funnel. Upon reaching proximity to the funnel wall, the one or more chemicals are released.

In step 103, the one or more chemicals interfere with the transfer of energy from the atmospheric air/water mixture to the tornado. The chemical and thermodynamic effects of introducing the chemicals into the funnel include, for example, inhibition of local water vaporization energy extraction, reduction of dynamic viscosity, and increase of local air pressure in the funnel. It should be understood that it is not necessary for all of these effects to occur along the entire length or circumference of a funnel.

A major source of the angular momentum in a tornado is wind shear occurring in the cloud scud above the funnel cloud. The wind shear arises typically from the collision of two or more weather fronts of differing moisture content and temperature. Since weather fronts have wind bands that run along the backside of the front, when two fronts intersect, the countervailing winds cause wind shear rotation about centers of rotation that is generally counter-clockwise in the northern hemisphere. The air mass in rotation drifts outward from the center of rotation due to centrifugal force, thereby evacuating the center of rotation and giving birth to a low-pressure area. The local air mass then follows Bernoulli's law:

p/γ+v²/2g+z=C

in which p/γ represents the pressure energy, v²/2 g represents the kinetic energy of wind speed v with gravitational acceleration g, z represents the gravity head of the air mass, and C is a constant. The resultant C must be constant as air flows in streamlines around the low pressure area. All terms can be expressed in foot-pounds/foot (ft-lbs/ft) or simply feet, or like other expressions in this application, in other equivalent units. Assuming the altitude of the air mass does not change, as it generally would not for a cross-section of the tornado, the gravity head does not change, but since the pressure decreases because of the centrifugal force evacuating the center, the kinetic energy must increase in order for their sum to remain constant. Thus, the velocity of the air mass must increase as the local atmospheric pressure decreases in the center of a tornado.

The one or more chemicals introduced into the tornado wall increase the slippage between adjacent cross-sections of the tornado's vortex, thereby enhancing a decrease in the local angular velocity from higher to lower cross-sections, step 104, and interfering with transmission down the funnel of rotational energy, or angular momentum, from the wind shear above, step 105. That interference leads to energy and rotational deficits (step 106) in the funnel as the funnel below the area of chemical introduction does not receive sufficient rotational energy from the funnel above the area of chemical introduction. If sufficient energy production shutdown and slowing of the rotational velocity transmission are accomplished at one funnel cross section, the funnel cannot make up the lost (i.e., not transmitted) energy and rotational deficit, and will become unstable and collapse.

For example, if there were very high viscosity in a funnel cloud's air/water mixture, then rotational energy, or torque, and angular momentum at the top of the funnel would be readily transmitted down the funnel to the base of the funnel, and so the base winds could rotate at nearly the same velocity as the winds at the top in the cloud scud. Of course, a funnel cloud's air/water mixture has a dynamic viscosity that results in some slippage, or loss, as it transmits the torque down the funnel; for an estimated 15% loss, a wind shear velocity of 100 feet per second at the top of a funnel would appear as winds of 85 feet per second at the base of the funnel.

Adding a chemical such as a petroleum distillate to a funnel cross-section at an intermediate height in accordance with this invention destabilizes a tornado by artificially decreasing the dynamic viscosity of the air/water/distillate mixture at that height, producing an additional estimated loss of about 10%, for example, so that the wind velocity at the base of the funnel would be reduced to 75 feet per second. That reduction would also increase the radius of gyration as debris falls to the ground. It would rapidly become impossible for the funnel system to maintain the value of the Bernoulli constant, and the funnel would collapse. As described above, chemicals introduced into a funnel can be selected from a group of petroleum distillates, ethers, alcohols, misted slip-glycerins, and waxes.

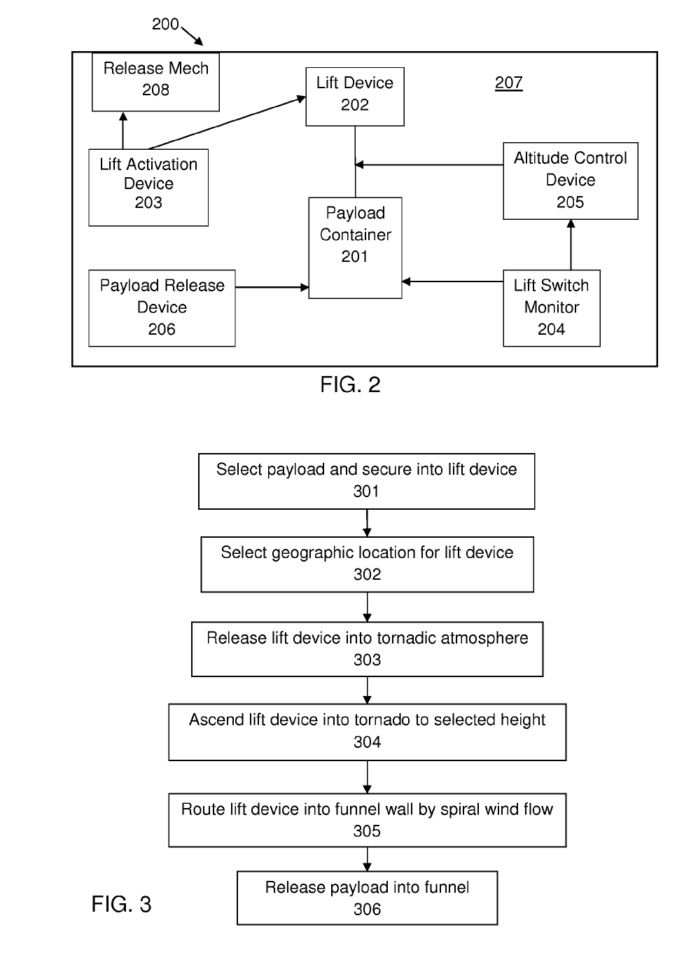

FIG. 2 is a block diagram of an apparatus 200 for directionally distributing at least one chemical into a tornado as described above. As depicted in FIG. 2, the apparatus 200 includes a payload container 201, a lift device 202 for carrying the container 201 to a selected height near a funnel cloud, a device 203 configured for activating the lift device, a lift switch monitor 204, a payload altitude control device 205, and a payload release device 206. It will be appreciated that the apparatus can be re-arranged in various ways and include other devices.

The apparatus 200 can advantageously include a watertight and weatherproof storage container or portable bag 207 that contains the payload container 201 of one or more chemicals that can be releasably attached to the lift device 202 and other devices for directional distribution of the payload. In one embodiment, the container 207 has a lid that is operable by a release mechanism 208. For example, the release mechanism 208 can include a hinge for the lid that is held closed against a coil spring under control of the lift activation device 203, a non-limiting example of which is a barometric-pressure controlled switch, or baroswitch. An advantageous baroswitch can be set to release the lid of the container 207, and any suitable associated latches, when the switch 203 detects a rapidly falling barometric pressure, signaling the approach of a tornado, and a pressure that is more than five per cent below ambient pressure. In addition or as an alternative, a radio or other suitable warning signal can be optionally transmitted by a control station to actuate the lift activation device 203.

Activation of the lift activation device 203 preferably also results in actuation of the lift device 202. In the embodiment described above, for example, activation of the lift activation device 203 not only releases a lid of the container 207 but also actuates or causes to be actuated a spring-loaded valve on a suitable bottle of pressurized helium or other lighter-than-air material included in the apparatus 200 and connected to the lift device 202. Opening the valve fills a number of balloons, such as conventional weather balloons, that constitute the lift device 202 and are releasably tethered to the container 207 and release mechanism 208 while they unfold and inflate. Upon activation, the lift device 202 lifts the payload container 201, altitude control device 205, and payload release device 206 to a selected height near the tornado, the lift device routing the payload container toward a wall of the tornado by spiral wind flow of the tornado.

The lift switch monitor 204, which can also be a baroswitch, is advantageously attached to the payload container 201 and lift device 202 and can monitor the lifting force generated by the lift device. The payload container 201 can include one or more containers for one or more chemicals, for example biologically non-toxic volatile petroleum distillates, ethers, alcohols, misted slip-glycerins, and waxes. The altitude of the payload container can be controlled by the altitude control device 205 such that when the payload and lift device reach a predetermined altitude, the altitude control device 205 releases the lift device 202 from the payload. It will be understood that the lift switch monitor 204 can perform the function of the altitude control device 205. For example, when the vertical lifting force measured by the lift switch monitor 204 exceeds the payload weight by at least about 30%, that ensures sufficient altitude gain so that the payload will be at a height of at least about 300 feet when it encounters the tornado debris cloud. At such a height, debris entrained by the funnel cloud will have little relative motion with respect to the payload container 201 and lift device 202 as they spiral in toward the funnel wall. This is particularly advantageous for balloons used as the lift device 202, as the probability of balloon puncture by collision with the debris field is markedly reduced by sufficient altitude and low relative velocity with the debris, and by use of puncture-resistant balloons, e.g., TEFLON polymer balloons.

The payload release device 206 operates such that it releases the one or more chemicals in the payload container 201 under a predetermined condition. For example, the payload container 206 can be a tilt monitor on the payload container 201 that is configured to open the payload container 201 when the centrifugal force of rotation of the payload container about the funnel wall tilts the payload container more than about sixty degrees from the vertical. Opening the payload container under that condition results in introduction of one or more chemicals, for example biologically non-toxic volatile petroleum distillates, ethers, alcohols, misted slip-glycerins, and waxes, into the funnel.

FIG. 3 is a flow chart that illustrates an example of a method of directionally distributing at least one chemical into a tornado, or more generally a tornadic atmosphere. In step 301, a payload of one or more chemicals is selected and secured to a suitable lift device, for example the lift device 202 of the apparatus 200. The payload and lift device are advantageously configured for safe housing and transport of the one or more chemicals. As described above, the payload can include a non-toxic mixture that decreases water evaporation and dynamic viscosity of the air-water mixture in the area of a funnel cloud into which the chemicals are introduced. Advantages of this approach include low cost, increased public safety, and reliance on existing technologies. In addition, the chemicals used can be readily varied and deployed rapidly.

In step 302, at least one geographic location is selected for placement of the payload and lift device. For example, one or more apparatuses 200 can be stationed along municipal and property boundaries away from overhead power lines in areas known to experience tornadoes, such as “Tornado Alley” in the mid-western states of the United States where a tornado funnel encounters flat plains and where surface friction is minimal. It is currently believed that heavily forested areas, or areas where there are large structures, generally make it much more difficult for a nascent funnel to get established with a suction seal on the ground.

One or more apparatuses can be located along farm property lines on the southwest borders as most tornados, once on the ground, transit from southwest to northeast in Tornado Alley. The apparatuses can be initially spaced about one tenth of a mile apart. For large tornadoes, which cause large barometric effects, an approaching funnel can be attacked by several lift devices and payloads to produce a larger destabilizing effect on the tornado, increasing the probability of tornado shut down.

In step 303, a lift device is released into a tornadic atmosphere, which is to say the atmosphere in the neighborhood of a tornado or developing tornado. This can be achieved manually or through the use of sensing devices as described above, or a combination of both. For example, a sensor that detects changes in barometric pressure, such as a baroswitch as described above, can release a lift device and payload into the atmosphere. Other examples of release include response to a radio transmission upon sighting of an approaching funnel; or opening a bag containing the lift device, manually initiating the lift device, and then taking shelter.

In step 304, the lift device/payload combination ascends into the atmosphere to a selected height, preferably above most of any entrained debris, e.g., at least about 300 feet, and then in step 305, the payload or the lift device/payload combination is routed into the tornado funnel wall by the spiral wind flow. The ascent can be achieved, for example, through the use of balloons, and the height can be controlled by a suitable an altitude control device, such as a lift switch that monitors the ascent release the lift device from the payload at the selected height, where the tornadic winds can swiftly carry the payload into the funnel cloud. For example, the large sail area of one or more balloons and the low mass of the balloons and payload would ensure that the inward component of the spiral wind flow will drive the payload into close proximity of the wall of the funnel.

In step 306, the payload is released into the tornado funnel. For example, a tilt monitor on the payload can be configured to open chemical bottles holding the payload when the centrifugal force on the bottles exceeds a selected value, with the result that the contents of the bottles spray into the funnel.

It is expected that this invention can be implemented in a wide variety of ways. It will be appreciated that procedures described above are carried out repetitively as necessary. To facilitate understanding, aspects of the invention are described in terms of actions that can be performed by, for example, elements of a programmable computer system or by specialized circuits, by program instructions executed by one or more processors, or by a combination of both.

Thus, the invention may be embodied in many different forms, not all of which are described above, and all such forms are contemplated to be within the scope of the invention. It is emphasized that the terms “comprises” and “comprising”, when used in this application, specify the presence of stated features, steps, or components and do not preclude the presence or addition of one or more other features, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

1. A method of distributing a chemical into a tornado, comprising:
selecting at least one chemical that interferes with transmission of angular momentum from a higher portion of the tornado to a lower portion of the tornado; and
directionally distributing the at least one chemical adjacent to a wall of the tornado by the tornado's spiral wind flow;
wherein the at least one chemical in the tornado decreases a local wind angular velocity at a portion of a cross-section of the tornado without initiating an explosion, thereby causing energy and rotational deficits within the tornado.

2. The method of claim 1, wherein the at least one chemical is selected from a group that includes petroleum distillates, ethers, alcohols, misted slip-glycerins, and waxes.

3. The method of claim 2, wherein the at least one chemical distributed in the tornado causes at least one of cooling rising moisture-laden air in and around the tornado and reducing a dynamic viscosity of an air/water mixture in the tornado.

4. The method of claim 1, wherein the at least one chemical in the tornado causes at least about a ten-percent additional local loss of angular momentum transmission.

5. The method of claim 1, wherein the at least one chemical is directionally distributed at a height above debris entrained by the tornado, and the at least one chemical is carried into a wall of the tornado by the tornado's spiral wind.

6. An apparatus for distributing into a tornado at least one chemical, comprising:
a payload container;
a lift device for lifting the payload container to a selected height near the tornado, the lift device routing the payload container toward a wall of the tornado by spiral wind flow of the tornado;
a lift activation device configured for activating the lift device;
a payload altitude control device configured for releasing the lift device from the payload container when the lift device and payload container reach a predetermined altitude; and
a payload release device configured for releasing content of the payload container at the predetermined altitude and upon occurrence of a predetermined condition, wherein the content includes the at least one chemical that decreases a local wind angular velocity at a portion of a cross-section of the tornado without initiating an explosion.

7. The apparatus of claim 6, further comprising a container for storing the payload container, lift device, lift activation device, payload altitude control device, and payload release device, wherein the payload container, lift device, and payload altitude control device are releasably stored in the container.

8. The apparatus of claim 7, wherein the container has a hinged lid that is configured to be held closed against a coil spring under control of the lift activation device.

9. The apparatus of claim 6, wherein the lift activation device includes a barometric-pressure controlled switch.

10. The apparatus of claim 6, wherein the lift device comprises at least one balloon, and the lift activation device is configured for actuating inflation of the at least one balloon with a lighter-than-air gas.

11. The apparatus of claim 6, wherein the payload container includes at least one container for at least one chemical, and the at least one chemical includes one or more of petroleum distillates, ethers, alcohols, misted slip-glycerins, and waxes.

12. The apparatus of claim 6, wherein the predetermined altitude is at least about 300 feet, and the payload release device is configured to open the payload container when a centrifugal force of rotation on the payload container tilts the payload container more than about sixty degrees from vertical.
